(19) United States
(12) Patent Application Publication
(10) Pub. No.: US 2007/0074499 A1
(43) Pub. Date: Apr. 5, 2007

(54) Y- type hay rake

(76) Inventor: Adelmo Giovannini, Montbcastelli (IT)

Correspondence Address: WILLIAM COLLARD;COLLARD & ROE, P.C., 1077 NORTHERN BOULEVARD, ROSLYN, NY, 11576, US

(21) Appl. No.: 10/576,669

(22) PCT Filed: Oct. 20, 2004
(86) PCT No.: PCT/EP04/52596

§ 371 Date: Apr. 21, 2006

(30) Foreign Application Priority Data
Oct. 24, 2003 (IT) RM2003A000493

(51) Int. Cl. A01D 78/00

(52) U.S. Cl. 56/378

(57) ABSTRACT

A rake provided with a frame (10) with vertical uprights (12, 13) on wheels (14, 15), in which the gathering arms (21, 22), each equipped with a plurality of rake wheels (23, 24), are of unequal length, the longer arm (e.g. 21) being hinged to one of the vertical uprights in an intermediate point, so as to project beyond said frame (10). In operation the arms (21, 22) are rotated about the intersections with the uprights (12,13), so as to form, in horizontal projection, a Y. With said arrangement, the first of the wheels (e.g. 23) of the longer arm (e.g. 21) surmounts the first rake wheel (e.g. 24) of the other arm (e.g. 22), in this way guaranteeing that all the material (grass or hay) to be gathered is effectively gathered.

### FIELD OF THE INVENTION

The present invention relates to a hay rake and, more in particular, relates to Y-type tractor towed agricultural equipment, for turning over the grass after it has been mowed and gathering it into windrows of adjustable width, said rake comprising two arms of unequal length, provided with rake wheels for moving the grass.

### STATE OF THE ART

In the agricultural field, it is known that after the grass, hay and the like has been mowed, the material that has been cut must be turned over, to ensure proper aeration, and then heaped together into windrows to facilitate gathering thereof. For this purpose machinery is used, referred to as rakes, which comprise two horizontal arms provided with fingerwheel hay rakes, or rake wheels, said arms having a roughly V-shaped configuration. Said arms are normally mobile on the horizontal plane in order to change the amplitude of opening of the V, according to the terrain on which the machinery has to work, and in order to bring said arms parallel to one another to reduce the overall dimensions of the machine during transportation or during garaging.

An example of said known machines is described in the U.S. Pat. No. 5,685,135, which describes a drawn rake provided with two mobile arms (each equipped with a plurality of rake wheels, referred to as “stellar” wheels, equipped with fine elongated teeth, having the shape of a rod with a complex curvature, for gathering and displacing the hay or grass), each of which is hinged by one of its own ends to a frame provided with wheels and can be actuated in rotation about the hinges in order to be able to modify the amplitude of opening of the V. This rake is characterised by the presence of hydraulic mechanisms for modifying said amplitude, arranged in such a way that each of them connects a central element, or drawbar, to one of said hinged arms.

Rakes of the above type present the drawback of leaving a strip of grass or hay not turned over and not displaced, corresponding to the amplitude of the wheeled frame, of fixed width and in general excessively wide.

A possible, at least partial, solution to the above drawback consists in the installation of a number of rake wheels also on the aforesaid wheeled frame. With this solution it is, in any case, necessary to equip the rake with means for raising or lowering also these further rake wheels, in addition to the ones set on said arms, for adapting the height of the wheels themselves to the terrain to be treated or to transportation, for example on the road. Moreover, the strip of grass left by the rake remains in any case too wide.

### BRIEF DESCRIPTION OF THE INVENTION

The purpose of the present invention is to eliminate the above drawback by proposing a rake of simple structure, and yet readily adaptable to any condition of terrain and capable of regulating within ample margins the amplitude of the strip, or windrow, of grass or hay that it leaves on the terrain after its passage.

The above purpose is achieved by providing a towable rake comprising a vertical frame formed by two vertical uprights on wheels connected at the top by a basically horizontal cross-member, each of said uprights being connected with a joint to a first working arm, which is also basically horizontal and carries a plurality of rake wheels. The horizontal cross-member is connected to a roughly horizontal transverse drawbar, connected in turn to said first horizontal arms by means of a pantograph formed by two pairs of second arms for actuation. The arms of a first pair are each connected by a first end to the drawbar and by a second end to a terminal point of said first horizontal arms, whilst the arms of the second pair are each connected, by one end, to the drawbar and, by the other end, to an intermediate point of one of the arms of said first pair, the ends connected to the drawbar of the arms of said first and second pairs being slidable along the drawbar so as to move said first horizontal arms from a resting position parallel to the drawbar and near thereto, to a working position in which the arms are divaricated with respect to the drawbar itself. The rake described briefly above is characterised in that: (i) one of said first working arms is hinged by a first of its own ends to one of said uprights of the vertical frame, whilst the other working arm is longer than the first and is hinged to the other vertical upright in a position corresponding to an intermediate point of its own length, thus projecting from the upright beyond the point of hinging of the first arm, said first arms, when in the working position, forming, in horizontal projection, a Y; (ii) said vertical uprights of the frame are each provided with a means of linear translation capable of bringing the ends of said first arms that are close to the frame itself closer to one another or moving them away from one another; (iii) said first horizontal working arms carrying the rake wheels are formed by the assembly of a number of modules that can vary as desired; (iv) said connecting joints between vertical uprights of the frame and horizontal arms carrying the rake wheels are Oldham couplings, capable of enabling movements of the arms in the vertical and horizontal directions; and (v) said drawbar carries means for controlling the movement of said first horizontal arms, by means of said pantograph, from the resting position to the working position, and vice versa.

Said means of linear translation for bringing the ends close to the frame of the arms carrying the rake wheels closer together and moving them further away from one another can be formed by hydraulic-control assemblies or, alternatively, mechanical-control assemblies.

In a first embodiment of the invention, the means for controlling the movement of said first arms from a working position to a resting position are formed by a hydraulic-control assembly. In another embodiment, said means for controlling the movement of said arms are formed by a mechanical-control assembly. Said means of linear translation capable of bringing the ends of said first arms that are close to the frame itself closer to one another or moving them away from one another are preferably formed by hydraulic pistons, but in any case can be formed by mechanical elements.

### BRIEF DESCRIPTION OF THE FIGURES

The present invention will now be described in greater detail in relation to a possible embodiment thereof illustrated, purely by way of non-limiting example, in the annexed plates of drawings, in which:

FIG. 1 illustrates a front schematic view of the rake according to the invention; and

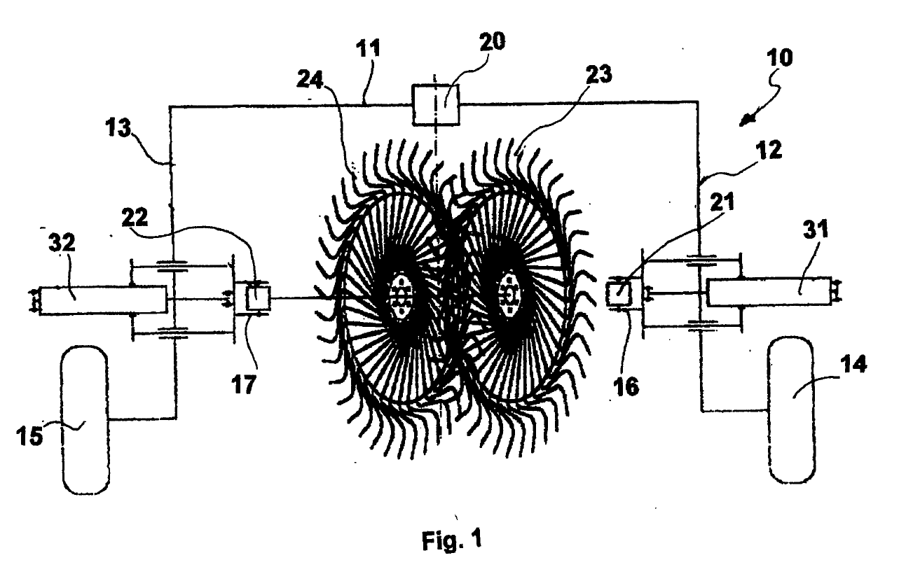

FIG. 2 illustrates a schematic plan view of the rake according to the invention.

### DETAILED DESCRIPTION OF THE INVENTION

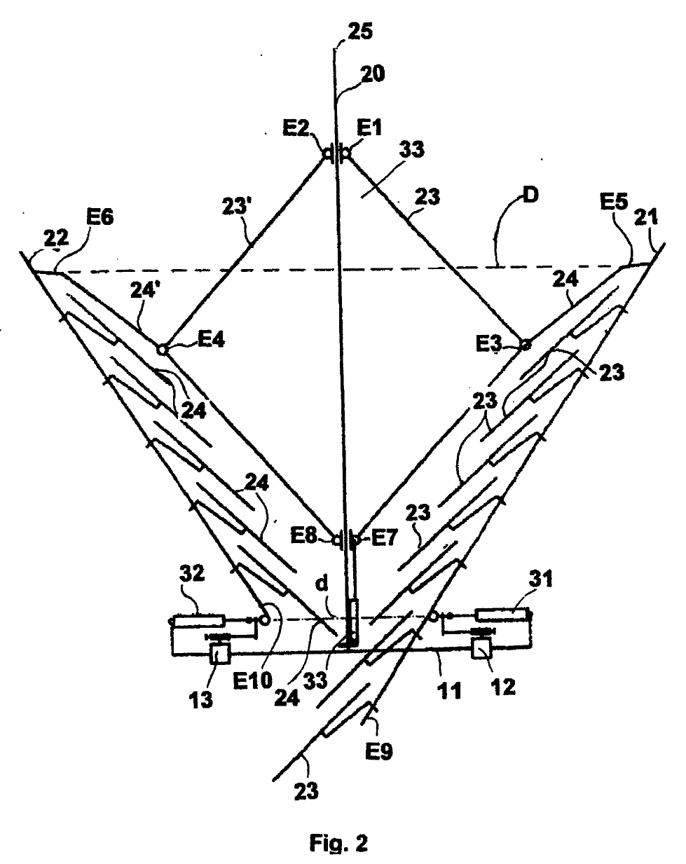

With reference to both of the figures, the rake according to the present invention comprises a vertical frame 10 basically formed by a roughly horizontal cross-member 11 connected to two roughly vertical uprights 12 and 13, provided with wheels 14 and 15. Each of the uprights supports, by means of articulated joints 16 and 17 respectively, one of the horizontal arms 21 and 22, each of which is equipped with a plurality of rake wheels 23 and 24. One of the horizontal arms 21, 22 is longer than the other and is hinged to the corresponding upright 12, 13 not in a position corresponding to one end (as is the other upright, in E10) but at a certain distance from said own end E9, so as to project beyond the cross-member 11. In this way (as may be seen in the figures) at least one of the terminal rake wheels of the longer arm (in FIG. 2, the wheel 23 of the arm 21) comes to surmount at least one of the terminal wheels connected to the other arm (in FIG. 2, the wheel 24 of the arm 22). During operation, this surmounting action enables overturning and removal of all the material, grass, hay and the like, over which the rake passes.

The cross-member 11 carries, right at the centre, a roughly horizontal axle 20, also referred to as drawbar, which is connected, via its own end 25, to towing means, for example a tractor (not illustrated). On said axle 20 there can slide, controlled by actuation devices 33 arranged on the drawbar 20, the ends E7 and E8 of the arms 24, 24′, the other ends E4 and E6 of which are connected in an articulated way to an intermediate point of the arms 24, 24′, the ends E5, E6 of which are connected to the arms 21 and 22, in the proximity of the free ends of the latter. With such a mechanism, by causing the ends E7, E8 of the arms 24, 24′ to slide along the drawbar 20, it is possible to move the free ends of the arms 21 and 22 away from the drawbar or bring them closer to the drawbar, thus modifying the distance D between said free ends and hence increasing or restricting the amplitude of action of the rake.

The pairs E1, E2 and E7, E8 each form a slide that slides along the drawbar 20, or along a tubular element (not illustrated) connected thereto.

The uprights 12 and 13 moreover carry actuation means 31 and 32, for example of a hydraulic type, connected respectively to the arms 21 and 22, for the purpose of bringing the parts of the arms 21 and 22 that are close to the cross-member 11 closer to one another or of moving them away from one another, in order to increase or reduce the distance (d) between said parts of the arms 21 and 22 and hence the superposition between the wheels 23 and 24. It is possible in this way to regulate the amplitude of the windrow of material, grass, hay or the like, moved, turned over, and accumulated in the movement of the rake.

1. A rake comprising a vertical frame (10) formed by two vertical uprights (12, 13) on wheels (14, 15), said uprights being connected at the top by a basically horizontal cross-member (11), each of said uprights being connected, by means of a joint (16, 17), to a first working arm (21, 22), which is also basically horizontal and carries a plurality of rake wheels (23, 24) uniformly distributed according to the length of said working arms, the horizontal cross-member being connected to a transverse drawbar (20), which is roughly horizontal, connected in turn to said first horizontal arms by means of a pantograph formed by two pairs of second arms for actuation, the arms (24, 24′) of a first pair being connected each by a first end (E7, E8) to the drawbar (20) and by a second end (E5, E6) to a terminal point of said first horizontal arms (21, 22), whilst the arms (23, 23′) of the second pair are each connected by one end (E1, E2) to the drawbar and by the other end (E3, E4) to an intermediate point of one of the arms of said first pair, the ends (E1, E2, E7, E8) of the arms of said first and second pairs being slidable along the drawbar so as to move said first horizontal arms (21, 22) from a resting position parallel to the draw-bar and near thereto, to a working position, in which the arms are divaricated with respect to the drawbar itself, said rake being characterised in that: (i) one of said first working arms (21, 22) is hinged to one of said uprights (12, 13) of the vertical frame (10) in a position corresponding to one of its own ends, whilst the other working arm is longer than the first one and is hinged to the other vertical upright in a position corresponding to an intermediate point of its own length, thus projecting from the upright beyond the point of hinging of the first arm, said first arms, when in the working position, forming, in horizontal projection, a Y; (ii) said vertical uprights (12, 13) of the frame (10) are each provided with a means of linear translation (31, 32) capable of bringing the ends of said first arms that are close to the frame itself closer to one another or moving them away from one another, thus modifying the distance (d); (iii) said first horizontal working arms (21, 22) carrying the rake wheels (23, 24) are formed by the assembly of a number of modules that can vary as desired; (iv) said connecting joints (16, 17) between vertical uprights (12, 13) of the frame (10) and horizontal arms (21, 22) carrying the rake wheels (23, 24) are Oldham couplings, capable of enabling movements of the arms (21, 22) in vertical and horizontal directions; and (v) said drawbar (20) carries means (33) for controlling the movement of said first horizontal arms, by means of said pantograph, from the resting position to the working position, and vice versa.

2. The rake according to claim 1, in which the rake wheels (23, 24) set on the working arm that is longer than the other and projecting beyond said horizontal cross-member (11) are arranged in front of the corresponding ones set on the shorter arm, so as to be superposed on the latter.

3. The rake according to claim 2, in which said superposition is at least partial.

4. The rake according to claim 1, in which said means (31, 32) are formed by a hydraulic-control assembly.

5. The rake according to claim 1, in which said means (31, 32) are formed by a mechanical-control assembly.

6. The rake according to claim 1, in which said means (33) for controlling the movement of said first working arms (21, 22) are formed by a hydraulic-control assembly.
